(19) United States
(12) Patent Application Publication
(10) Pub. No.: US 2026/0329160 A1
(43) Pub. Date: Oct. 22, 2026

(54) OPTICAL PROJECTION MODULE AND ELECTRONIC DEVICE HAVING THE SAME

(71) Applicant: TRIPLE WIN TECHNOLOGY (SHENZHEN) CO.LTD., Shenzhen (CN)

(72) Inventor: KUAN-MING CHEN, New Taipei (TW)

(21) Appl. No.: 19/299,766

(22) Filed: Aug. 14, 2025

(30) Foreign Application Priority Data
Apr. 18, 2025 (CN) 202510493073.7

(51) Int. Cl. G03B 21/20

(52) U.S. Cl. CPC G03B 21/208

(57) ABSTRACT

The present disclosure provides an optical projection module and an electronic device having the same. The optical projection module includes a light source unit, a lens unit, and a lens module arranged sequentially along a light-emitting direction. The light source unit includes multiple first light-emitting regions and multiple second light-emitting regions. The light sources of the first light-emitting region and second light-emitting region can be controlled independently. The lens unit includes multiple lenses. An orthographic projection of each lens onto the light source unit covers one first light-emitting region while not covers the second light-emitting region. The lens can modify a light emitting angle of the light beam emitted from the first light-emitting region. Wherein the optical projection module can form different patterns by the first light beams and the second light beams, respectively.

### CROSS-REFERENCE TO RELATED APPLICATION

This application claims the benefit and priority to Chinese Patent Application Serial No. 202510493073.7, filed on Apr. 18, 2025, filed in China State Intellectual Propoerty Administration, entitled “OPTICAL PROJECTION MODULE AND ELECTRONIC DEVICE HAVING THE SAME”, and the content of which is hereby fully incorporated by reference.

### FIELD

The subject matter relates to optics, and more particularly, to an optical projection module, and an electronic device with the optical projection module.

### BACKGROUND

With the development of virtual reality (VR), augmented reality (AR), medical imaging, and industrial design, three-dimensional (3D) optical projection technology has gradually become a hotspot for research.

At present, 3D optical projection technologies primarily include structured light ranging and time-of-flight (TOF) ranging. The structured light ranging and TOF ranging both require optical projection modules to emit dot array lights. There are two types of optical projection modules. The first type of the optical projection module can emit dot array patterns, and the second type of the optical projection module can emit flood light pattern. Although each type of the optical projection module is somewhat useful, a new optical projection module is still needed.

Therefore, there is room for improvement in the art.

### BRIEF DESCRIPTION OF THE DRAWINGS

Implementations of the present technology will now be described, by way of example only, with reference to the attached figures.

FIG. 1 is a diagrammatic view of an optical projection module according to an embodiment of the present disclosure.

FIG. 2 is an exploded view of an embodiment of the optical projection module shown in FIG. 1.

FIG. 3 is a layout view of an embodiment of light sources in the optical projection module shown in FIG. 1.

FIG. 4 is a diagrammatic view showing a lens unit assembled on a first light-emitting region according to an embodiment of the present disclosure.

FIG. 5 is a photo of an embodiment of a floodlight pattern projected by the optical projection module shown in FIG. 1.

FIG. 6 is a photo of an embodiment of a dot array pattern projected by the optical projection module shown in FIG. 1.

FIG. 7 is a diagrammatic view of an optical projection module according to another embodiment of the present disclosure.

FIG. 8 is an exploded view of an embodiment of the optical projection module shown in FIG. 7.

FIG. 9 is a diagrammatic view showing a lens unit assembled on a first light-emitting region according to another embodiment of the present disclosure.

FIG. 10 is a diagrammatic view of an optical projection module according to yet another embodiment of the present disclosure.

FIG. 11 is a diagrammatic view of an electronic device according to an embodiment of the present disclosure.

### DETAILED DESCRIPTION

It will be appreciated that for simplicity and clarity of illustration, where appropriate, reference numerals have been repeated among the different FIG.s to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

At present, there are three implementation approaches for switching dot array patterns and flood light patterns.

In an embodiment, a first optical projection module includes a light source, and an optical element disposed on the light-emitting surface of the light source. The position of the optical element or the light source can be adjusted to achieve the purpose of switching a dot array pattern or a flood light pattern. For example, a driving mechanism is needed in the first optical projection module to adjust the position of the optical element or the light source. However, the driving mechanism may increase the structural complexity and the high assembly precision of the first optical projection module. It needs a long moving path in the first optical projection module which may increase the cost of the first optical projection module. Furthermore, there is a potential misalignment between the optical element and the light source during the movement, leading to subpar dot light presentation.

In another embodiment, a second optical projection module includes a light source, and an optical element disposed on the light-emitting surface of the light source. The focal power of the optical element can be adjusted to achieve the purpose of switching a dot array pattern or a flood light pattern. For example, a surface curvature of the optical element can be adjusted to change the focal power, thereby enabling switching between dot light and flood light. However, the optical element with adjustable focal power has a complex structure, presents significant manufacturing challenges, incurs high costs, and demands high assembly precision. Furthermore, inadequate switching can easily result in poor dot light presentation.

In yet another embodiment, a third optical projection module includes two types of light sources, and an optical element disposed on the light-emitting surfaces of the light sources. One of the two types of light sources is used to emit dot light, and another one is used to emit flood light. By switching the two types of light sources can achieve the purpose of switching a dot array pattern or a flood light pattern. However, due to the two different types of light sources in the third optical projection module, both the manufacturing difficulty and cost have increased. It is difficult to assemble the two different types of light sources in the third optical projection module, and the volume of the third optical projection module is increased.

However, these techniques exhibit limitations that hinder industrial applicability.

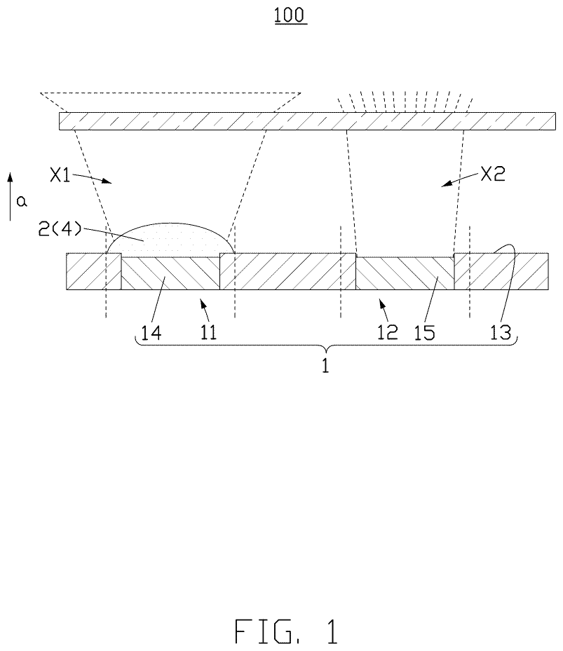

To solve the problems mentioned above, referring to FIGS. 1 to 3, an optical projection module 100 is provided according to an embodiment of the present disclosure. The optical projection module 100 includes a light source unit 1, a lens unit 2, and a lens module 3. The lens unit 2 and the lens module 3 arranged sequentially along a light-emitting direction “a” of the light source unit 1.

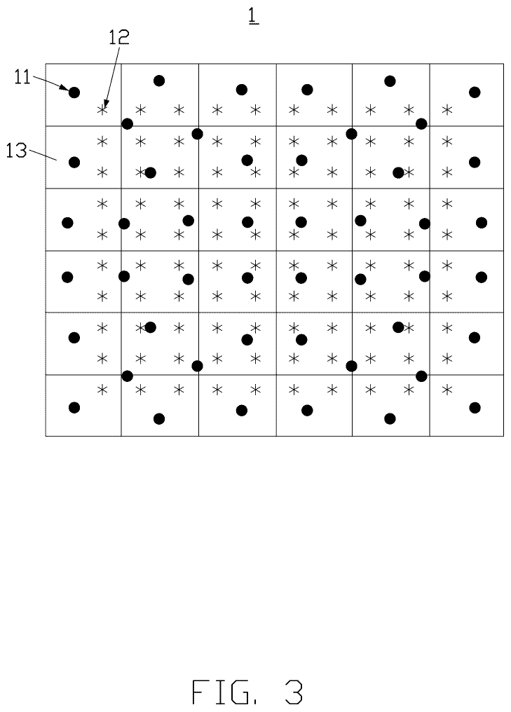

Referring to FIG. 3, the light source unit 1 includes a plurality of first light-emitting regions 11 and a plurality of second light-emitting regions 12. The plurality of first light-emitting regions 11 are arranged in an array, and any two adjacent first light-emitting regions 11 are spaced apart. The plurality of second light-emitting regions 12 are arranged in an array, and any two adjacent second light-emitting regions 12 are spaced apart.

Each first light-emitting region 11 includes at least one first light source 14, and each second light-emitting region 12 includes at least one second light source 15. In other words, the light source unit 1 can comprise a large number of light sources arranged in an array, and these light sources can be divided into two groups, with one group forming the first light sources 14 and the other group forming the second light sources 15. The array of the first light sources 14 and the second light sources 15 can be regular arrays or irregular arrays (such as randomly arranged). The arrangement pattern of the first light-emitting regions 11 and the second light-emitting regions 12 determines patterns of the light spots emitted by the optical projection module 100, which can be designed according to actual requirements. For example, the first light-emitting regions 11 and the second light-emitting regions 12 can be arranged in an interlaced manner.

The first light source 14 and the second light source 15 can emit light independently. The first light source 14 and the second light source 15 can be independently controlled. Which means that, the turning on or off of the first light sources 14 can be controlled independently, and the same applies to the turning on or off of the second light source 15. The turning on or off of the light sources in the two light-emitting regions do not interfere with each other. When the first light sources 14 need to be turned on, the second light sources 15 can be turned off, and vice versa, facilitating the switching between the light sources of the two light-emitting regions.

The first light source 14 and the second light source 15 are a same light source. The first light source 14 and the second light source 15 have the same characteristics, such as wavelength and light emitting angle. In an embodiment, both the first light-emitting regions 11 arranged in an array and the second light-emitting regions 12 arranged in an array are capable of emitting dot array lights.

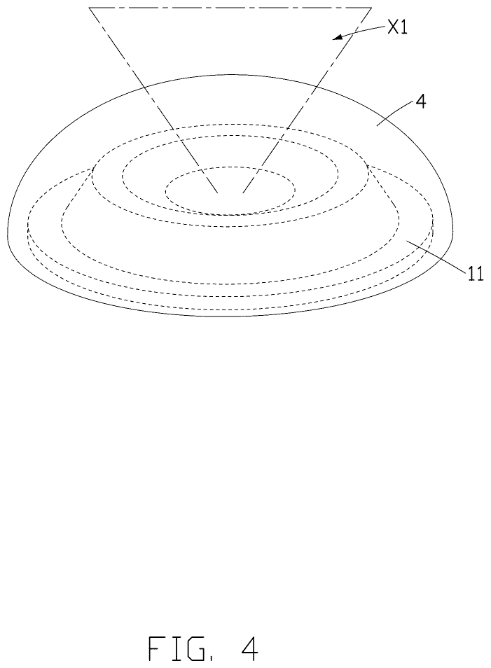

In an embodiment, the light source unit 1 can be a Vertical-Cavity Surface-Emitting Laser (VCSEL). As shown in FIG. 4, it illustrates a structure of a single light-emitting aperture within the light source unit 1. Each light-emitting aperture in light source unit 1 can serve as an individual light source, and a single light-emitting aperture constitutes one of the light-emitting regions (such as, the first light-emitting region 11 or the second light-emitting region 12). Moreover, each light-emitting aperture shares the same characteristics, such as wavelength and light emitting angle.

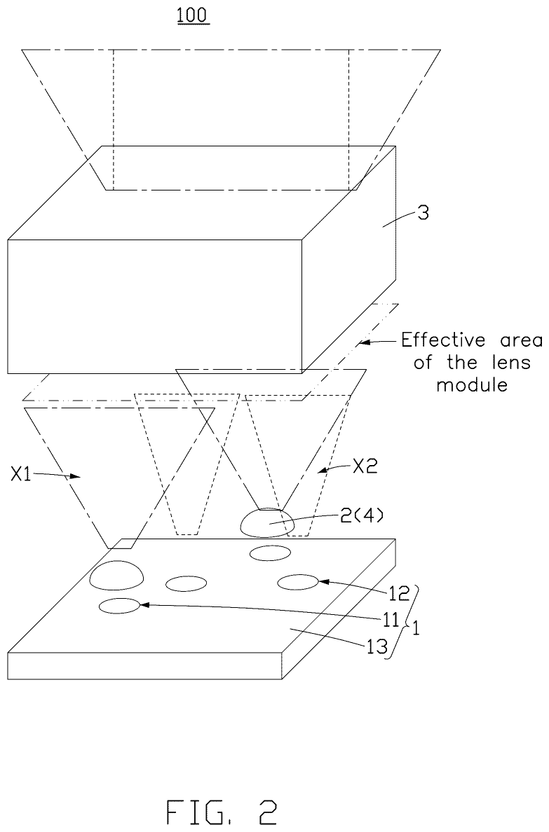

Referring to FIGS. 1 and 2, the light source unit 1 further includes a light-emitting surface 13. The lens unit 2 is facing the light-emitting surface 13 of the light source unit 1. The lens unit 2 includes a plurality of lenses 4. An orthographic projection of each lens 4 onto the light source unit 1 covers one first light-emitting region 11 while not covers any one of the second light-emitting regions 12. The first light source 14 at each first light-emitting region 11 is configured to emit first light beams X1 toward the corresponding one of the lenses 4. The lens 4 is configured to change a light emitting angle of the first light beams X1 and direct the first light beams X1 toward the lens module 3. The second light source 15 at each second light-emitting region 12 is configured to emit second light beams X2 toward the lens module 3. And the second light beams X2 will not pass through the lens 4. Thus, the optical projection module 100 is configured to form different patterns by the first light beams X1 and the second light beams X2, respectively.

After the same light sources emit identical light beams, some of the beams (such as the first light beams X1) pass through the lenses 4, while other beams (such as the second light beams X2) do not. Consequently, the light emitting angle of the first light beams X1 that passes through the lenses 4 will be altered, resulting in a light pattern that differs from that of the second light beams X2. Thus, by independently turning on either the first light-emitting region 11 or the second light-emitting region 12, it becomes possible to switch between two or even multiple light patterns.

Depending on the structure of the lens 4, the light emitting angle of the first light beams X1 passing through the lenses 4 may decrease, increase, or undergo asymmetric changes along X-axis and Y-axis (such as forming an elliptical beam). Consequently, a beam with a small light emitting angle ultimately corresponds to form a dot pattern, a beam with a large light emitting angle corresponds to form a floodlight pattern, and a beam with asymmetric angular changes corresponds to form a line pattern. Thus, the structure of the lens 4 can be designed according to actual needs to achieve the desired light pattern.

In an embodiment, the lens 4 can increase the light emitting angle of the first light beams X1. As a result, the light emitting angle of the first light beams X1 increase while that of the second light beams X2 remains unchanged. Thus, when all the first light-emitting regions 11 are turned on, the optical projection module 100 can project a floodlight pattern. When all the second light-emitting regions 12 are turned on, the optical projection module 100 can project a dot array pattern. The floodlight pattern and the dot array pattern can be switched by switching between the first light-emitting regions 11 and the second light-emitting regions 12. Furthermore, the array distribution of the first light-emitting regions 11 is relatively uniform, which helps improve the uniformity of the floodlight pattern.

In other embodiments, the lens unit 2 may include different lenses 4. Different lenses 4 can be used in combination, enabling some of the first light-emitting regions 11 to emit lights to form a floodlight pattern while others emit lights to form a line pattern. When combining with the dot array pattern emitted by the second light-emitting regions 12, this configuration allows the optical projection module 100 to switch among three different light patterns.

Referring to FIGS. 1 and 4, the lenses 4 can be directly formed on a surface of the light source unit 1. In an embodiment, the lenses 4 can be directly formed on the surface of the first light-emitting region 11, meaning that the lenses 4 directly cover the first light-emitting region 11. In this way, the numerous lenses 4 formed on the light-emitting surface 13 of the light source unit 1 constitute the lens unit 2.

In an embodiment, the lenses 4 can be microlenses directly formed on the surface of each first light-emitting region 11. For example, UV-curable adhesive can be directly dripped onto the surface of each first light-emitting region 11 and covered the first light-emitting region 11 completely. Subsequently, the adhesive droplets are cured to form a large number of lenses 4 on the light-emitting surface 13 of the light source unit 1.

Referring to FIGS. 1 and 2, the lens module 3 is disposed on a side of the lens unit 2 away from the light source unit 1. The lens module 3 includes at least one selected from the group of an optical lens, a diffractive element, and a metalens. The structure and type of the lens module 3 are determined by the functional requirements of the optical projection module 100 and the distribution of the light-emitting regions of the light source unit 1. Through the coordinated operation of the light source unit 1, the lens unit 2, and the lens module 3, the optical projection module 100 is capable of projecting two or more types of patterns within the required operating range.

The principle of switching between dot light and floodlight using the optical projection module 100 is as follows. Since the light sources on the first light-emitting regions 11 and the second light-emitting regions 12 of the light source unit 1 are the same type and can be independently controlled. For example, both the first light beams X1 emitted by the first light-emitting region 11 and the second light beams X2 emitted by the second light-emitting region 12 are dot light beams, and the lenses 4 in the lens unit 2 can increase the light emitting angle of the first light beams X1. Thus, when all the first light-emitting regions 11 are turned on, the light emitting angle of the first light beams X1 are increased after passing through the lenses 4, causing dispersion of the first light beams X1. Any two adjacent light spots of the first light beams X1 can overlap each other after dispersion, meaning that the size of each light spot increases. When the density of the spots is sufficiently high, multiple first light beams X1 with large light emitting angles will merge into a continuous area. After subsequent processing of the light by the lens module 3, the optical projection module 100 emits light in a floodlight pattern. Conversely, when the first light-emitting regions 11 are turned off and the second light-emitting regions 12 are turned on, the second light beams X2 do not pass through the lenses 4 but instead pass through the gaps among the lenses 4, maintaining the light emitting angles unchanged. Then the second light beams X2 directly pass through the lens module 3 to form a dot array pattern.

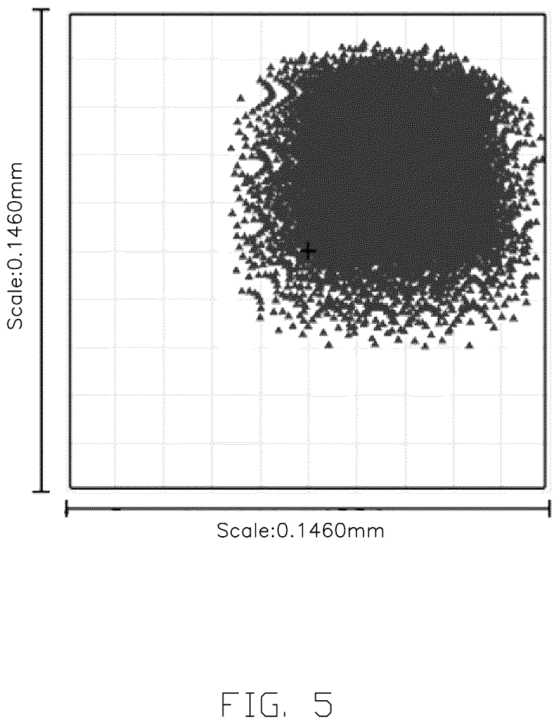

In an embodiment, referring to FIGS. 2 and 5, one-fourth of the first light-emitting regions 11 in the light source unit 1 are turned on. The light emitting angle of the first light beams X1 after passing through the lens 4 is approximately 50°. Then the first light beams X1 may form a floodlight pattern after passing through the lens module 3.

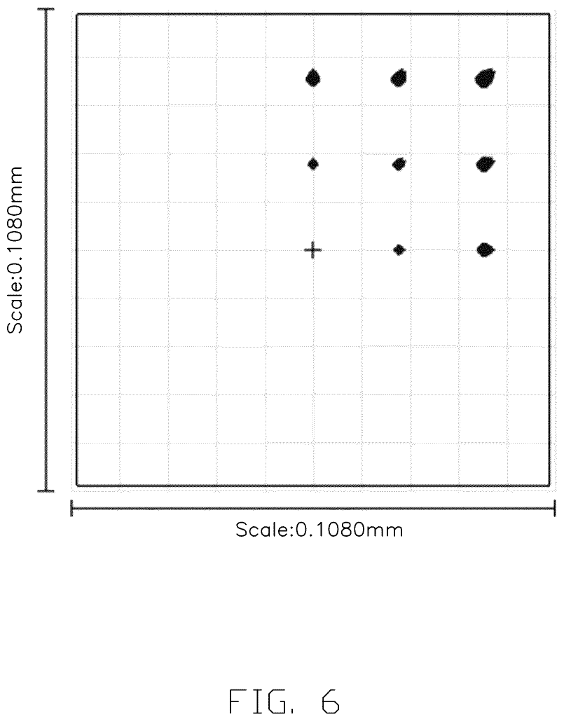

In an embodiment, referring to FIGS. 2 and 6, one-fourth of the second light-emitting regions 12 in the light source unit 1 are turned on, and the light emitting angle of the second light beams X2 is approximately 20°. Then the second light beams X2 may form a dot array pattern after passing through the lens module 3.

The floodlight pattern has advantages of high lateral resolution and suitability for dark environments. Meanwhile the dot array (or speckle light) pattern has advantages of low power consumption, high signal-to-noise ratio, and long working distance.

Depending on the distribution pattern of the first light-emitting regions 11 and the combination type of the lenses 4, the optical projection module 100 can project two or more different patterns, such as dot array pattern, random dot-light pattern, line-light pattern, line-light array pattern, and floodlight pattern.

The optical projection module 100 can switch between at least two light patterns, such as switch between dot light and flood light. This effectively combines the advantages of both dot light and flood light, thereby improving an overall performance of the optical projection module 100.

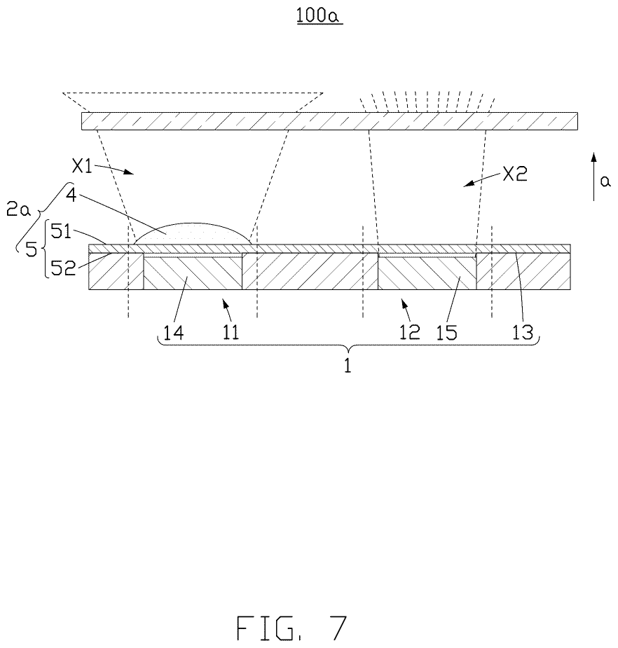

Referring to FIG. 7, an optical projection module 100a is provided according to another embodiment of the present disclosure. The structure of the optical projection module 100a is substantially the same as that of the optical projection module 100. The optical projection module 100a includes a light source unit 1, a lens unit 2a, and a lens module 3. The main difference is that the lens unit 2a further includes a transparent dielectric layer 5. The lenses 4 are disposed on the transparent dielectric layer 5. The arrangement and the functions of the lenses 4 in the optical projection module 100a are substantially the same as those of the lenses 4 in the optical projection module 100.

In an embodiment, the first light-emitting regions 11 are covered by the lenses 4, and an orthographic projection of each second light-emitting region 12 onto the transparent dielectric layer 5 is at a gap between any two adjacent lenses 4. The transparent dielectric layer 5 does not change the light emitting angle of the second light beams X2 emitted from the second light-emitting regions 12.

In an embodiment, the transparent dielectric layer 5 includes a first surface 51 and a second surface 52 opposite to the first surface 51. The first surface 51 is away from the light source unit 1, and the second surface 52 is close to the light source unit 1. The lenses 4 are disposed on the first surface 51. In an embodiment, the lens unit 2a can be directly attached to the light-emitting surface 13 of the light source unit 1, which enables the volume of the optical projection module 100a to be minimized.

In another embodiment, the lens unit 2a can also be spaced apart from the light source unit 1. The second surface 52 will not be attached to the light-emitting surface 13 of the light source unit 1, and there is a certain distance between the second surface 52 and the light-emitting surface 13.

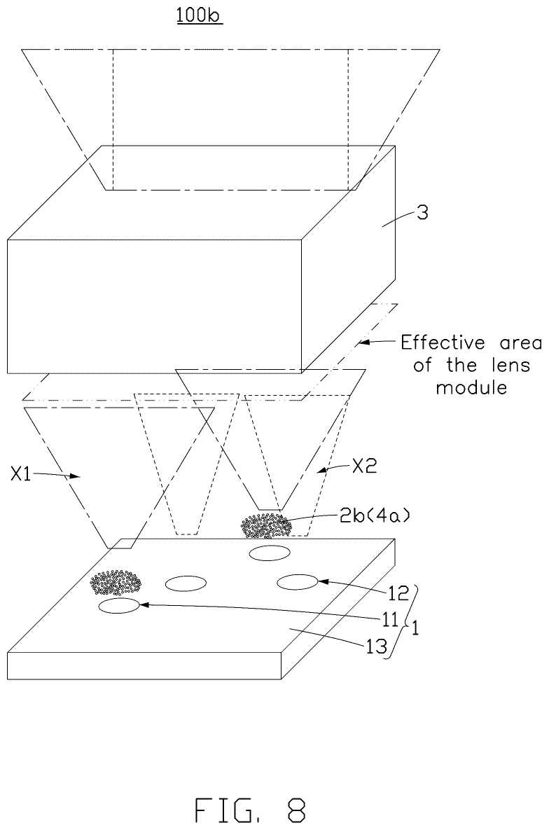

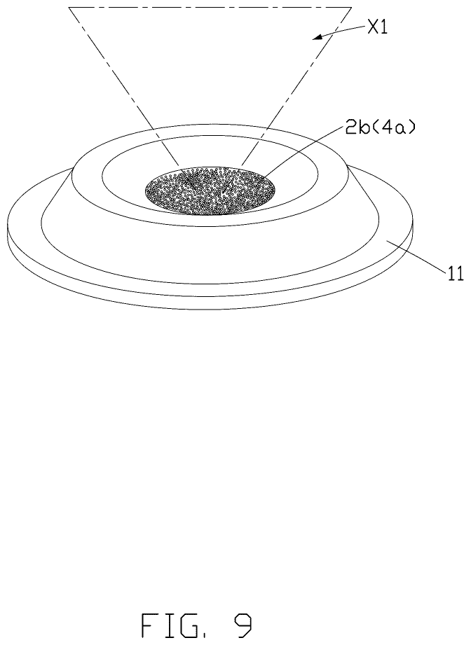

Referring to FIGS. 8 and 9, an optical projection module 100b is provided according to yet another embodiment of the present disclosure. The structure of the optical projection module 100b is substantially the same as that of the optical projection module 100. The optical projection module 100b includes a light source unit 1, a lens unit 2b, and a lens module 3. The lens unit 2b includes multiple lenses 4a. The orthographic projection of each lens 4a onto the light source unit 1 covers one of the first light-emitting regions 11, while the second light-emitting regions 12 are not covered by the lenses 4a. The functions of the lens 4a are substantially the same as those of the lens 4 in the optical projection module 100. The main difference is that the lenses 4a are metalenses, which are directly formed on the surface of each first light-emitting region 11 through the fabrication process of metalenses.

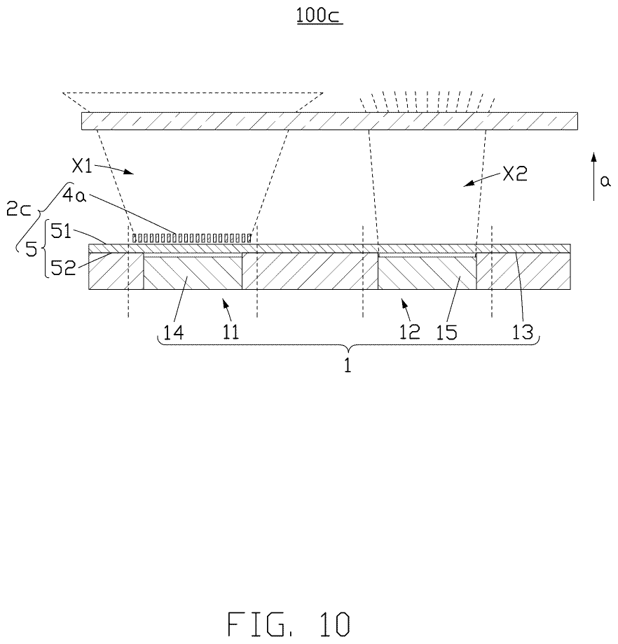

Referring to FIG. 10, an optical projection module 100c is provided according to yet another embodiment of the present disclosure. The structure of the optical projection module 100c is substantially the same as that of the optical projection module 100b. The optical projection module 100c includes a light source unit 1, a lens unit 2c, and a lens module 3. The main difference is that the lens unit 2c includes multiple lenses 4a and a transparent dielectric layer 5. The lenses 4a are disposed on the transparent dielectric layer 5. The arrangement and the functions of the lenses 4a in the optical projection module 100c are substantially the same as those of the lenses 4a in the optical projection module 100b.

In an embodiment, the first light-emitting regions 11 are covered by the lenses 4a, and an orthographic projection of each second light-emitting region 12 onto the transparent dielectric layer 5 is at the gap between any two adjacent lenses 4a. The transparent dielectric layer 5 does not change the light emitting angle of the second light beams X2 emitted from the second light-emitting regions 12.

In an embodiment, the transparent dielectric layer 5 includes a first surface 51 and a second surface 52 opposite to the first surface 51. The first surface 51 is away from the light source unit 1, and the second surface 52 is close to the light source unit 1. The lenses 4a are disposed on the first surface 51. In an embodiment, the lens unit 2c can be directly attached to the light-emitting surface 13 of the light source unit 1, which enables the volume of the optical projection module 100c to be minimized.

In another embodiment, the lens unit 2c can also be spaced apart from the light source unit 1. The second surface 52 will not be attached to the light-emitting surface 13 of the light source unit 1, and there is a certain distance between the second surface 52 and the light-emitting surface 13.

In the optical projection module 100 (100a, 100b, or 100c) of the above embodiments, by incorporating lens unit 2 (2a, 2b, or 2c), the light beams emitted from the first light-emitting regions 11 in the light source unit 1 passes through the lenses 4 (or 4a) of the lens unit 2 (2a, 2b, or 2c), while the light beams emitted from the second light-emitting regions 12 do not pass through the lenses 4 (or 4a). In this way, by switching between the first light-emitting regions 11 and the second light-emitting regions 12, the optical projection module 100 (100a, 100b, or 100c) can project at least two different light patterns. The switching of light patterns is simpler and more convenient, with a simple structure and a small volume, which is conducive to making the optical projection module thinner and lighter.

Moreover, the positions of the lenses 4 (or 4a) in the lens unit 2 (2a, 2b, or 2c) are fixed, enabling a more precise match with the first light-emitting regions 11. There will be no misalignment caused by pattern switching, and there is no need to modify the lenses 4 (or 4a) during the switching process. Thus, the projected light patterns from the optical projection module 100 (100a, 100b, or 100c) have higher precision.

Furthermore, the light sources in different regions of the light source unit 1 can be the same, reducing the cost and manufacturing difficulty of the light source unit 1. There is also no need to design a complex driving structure, which lowers the overall structural complexity and volume of the optical projection module 100 (100a, 100b, or 100c).

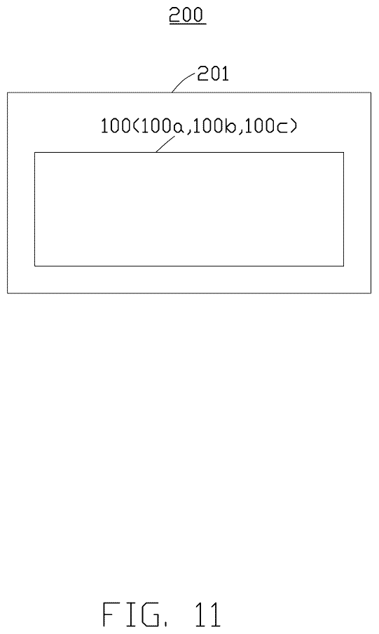

Referring to FIG. 11, an electronic device 200 is provided according to an embodiment of the present disclosure. The electronic device 200 includes a housing 201 and the optical projection module 100 (100a, 100b, 100c) disposed in the housing 201. The optical projection module 100 (100a, 100b, 100c) is used to project at least two types of patterns. The optical projection module 100 (100a, 100b, 100c) can be applied in various scenarios. For example, the electronic device 200 can include, but is not limited to, mobile terminals such as mobile phones, tablet computers, notebook computers, palmtop computers, personal computers (PCs), personal digital assistants (PDAs), portable media players (PMPs), navigation devices, wearable devices, smart wristbands, pedometers, as well as fixed terminals like digital TVs and desktop computers.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. An optical projection module comprising:
a light source unit comprising a plurality of first light-emitting regions arranged in an array and a plurality of second light-emitting regions arranged in an array, each of the plurality of first light-emitting regions comprising a first light source, each of the plurality of second light-emitting regions comprising a second light source, wherein the first light source and the second light source is independently controlled, the light source unit further comprises a light-emitting surface;
a lens unit facing the light-emitting surface of the light source unit, the lens unit comprising a plurality of lenses, wherein an orthographic projection of each of the plurality of lenses onto the light source unit covers a corresponding one of the plurality of first light-emitting regions, the orthographic projections of the plurality of lenses do not cover the plurality of second light-emitting regions; and
a lens module disposed on a side of the lens unit away from the light source unit, wherein the first light source at each of the plurality of first light-emitting regions is configured to emit first light beams toward the corresponding one of the plurality of lenses, each of the plurality of lenses is configured to change a light emitting angle of the first light beams and direct the first light beams toward the lens module, and the second light source at each of the plurality of second light-emitting regions is configured to emit second light beams toward the lens module;
wherein the optical projection module is configured to form different patterns by the first light beams and the second light beams, respectively.

2. The optical projection module according to claim 1, wherein the first light source and the second light source are a same light source.

3. The optical projection module according to claim 1, wherein the pattern formed by the first light beams is a dot pattern, a floodlight pattern, or a line pattern.

4. The optical projection module according to claim 1, wherein the pattern formed by the first light beams is a floodlight pattern, and the pattern formed by the second light beams is a dot array pattern.

5. The optical projection module according to claim 1, wherein the lens unit further comprises a transparent dielectric layer, the plurality of lenses is disposed on the transparent dielectric layer, and an orthographic projection of each of the plurality of second light-emitting regions onto the transparent dielectric layer is at a gap between two adjacent of the plurality of lenses.

6. The optical projection module according to claim 5, wherein the transparent dielectric layer comprises a first surface and a second surface opposite to the first surface, the first surface is away from the light source unit, and the plurality of lenses is disposed on the first surface.

7. The optical projection module according to claim 5, wherein the lens unit is formed on the light source unit or spaced apart from the light source unit.

8. The optical projection module according to claim 1, wherein each of the plurality of lenses is disposed on the light-emitting surface of the light source unit and covers each of the plurality of first light-emitting regions.

9. The optical projection module according to claim 1, wherein each of the plurality of lenses is a microlens or a metalens.

10. The optical projection module according to claim 1, wherein the lens module comprises at least one of an optical lens, a diffractive element, and a metalens.

11. An electronic device comprising:
a housing; and
an optical projection module comprising:
a light source unit comprising a plurality of first light-emitting regions arranged in an array and a plurality of second light-emitting regions arranged in an array, each of the plurality of first light-emitting regions comprising a first light source, each of the plurality of second light-emitting regions comprising a second light source, wherein the first light source and the second light source is independently controlled, the light source unit further comprises a light-emitting surface;
a lens unit facing the light-emitting surface of the light source unit, the lens unit comprising a plurality of lenses, wherein an orthographic projection of each of the plurality of lenses onto the light source unit covers a corresponding one of the plurality of first light-emitting regions, the orthographic projection of the plurality of lenses do not cover the plurality of second light-emitting regions; and
a lens module disposed on a side of the lens unit away from the light source unit,
wherein the first light source at each of the plurality of first light-emitting regions is configured to emit first light beams toward the corresponding one of the plurality of lenses, each of the plurality of lenses is configured to change a light emitting angle of the first light beams and direct the first light beams toward the lens module, and the second light source at each of the plurality of second light-emitting regions is configured to emit second light beams toward the lens module;
wherein the optical projection module is configured to form different patterns by the first light beams and the second light beams, respectively.

12. The electronic device according to claim 11, wherein the first light source and the second light source are a same light source.

13. The electronic device according to claim 11, wherein the pattern formed by the first light beams is a dot pattern, a floodlight pattern, or a line pattern.

14. The electronic device according to claim 13, wherein the pattern formed by the first light beams is a floodlight pattern, and the pattern formed by the second light beams is a dot array pattern.

15. The electronic device according to claim 11, wherein the lens unit further comprises a transparent dielectric layer, the plurality of lenses is disposed on the transparent dielectric layer, and an orthographic projection of each of the plurality of second light-emitting regions onto the transparent dielectric layer is at a gap between two adjacent of the plurality of lenses.

16. The electronic device according to claim 15, wherein the transparent dielectric layer comprises a first surface and a second surface opposite to the first surface, the first surface is away from the light source unit, and the plurality of lenses is disposed on the first surface.

17. The electronic device according to claim 5, wherein the lens unit is formed on the light source unit or spaced apart from the light source unit.

18. The electronic device according to claim 11, wherein each of the plurality of lenses is disposed on the light-emitting surface of the light source unit and covers each of the plurality of first light-emitting regions.

19. The electronic device according to claim 11, wherein each of the plurality of lenses is a microlens or a metalens.

20. The electronic device according to claim 11, wherein the lens module comprises at least one of an optical lens, a diffractive element, and a metalens.
